(19) United States
(12) Patent Application Publication
(10) Pub. No.: US 2002/0062370 A1
(43) Pub. Date: May 23, 2002

(54) Information gathering system

(76) Inventors: Dimitris Agouridis, Calgary (CA); Shui Hung Kwok, Calgary (CA)

Correspondence Address: BORDEN LADNER GERVAIS, LLP, 1000 - 60 QUEEN STREET, OTTAWA, ON, K1P 5Y7, CA

(21) Appl. No.: 09/906,714

(22) Filed: Jul. 18, 2001

Related U.S. Application Data
(60) Provisional application No. 60/219,106, filed on Jul. 19, 2000.

(51) Int. Cl. G06F 15/173

(52) U.S. Cl. 709/224; 709/223

(57) ABSTRACT

An information gathering system for gathering information over a network is provided. The system includes at least one subject computer having subject computer software for creating at least one time/data file relating to current subject computer conditions and a database connected to the subject computer for receiving and storing a plurality of time/data files and for sending at least one time/data file to at least ore control computer. The system is particularly suited for providing surveillance over local and wide area networks.

### FIELD OF THE INVENTION

An information gathering system for gathering information over a network is provided. The system includes at least one subject computer having subject computer software for creating at least one time/data file relating to current subject computer conditions and a database connected to the subject computer for receiving and storing a plurality of time/data files and for sending at least one time/data file to at least one control computer. The system is particularly suited for enabling surveillance over local and aide area networks.

### BACKGROUND OF THE INVENTION

The personal computer (PC) has become one of the most important technical tools assisting people in their daily lives in work, educational, and home settings. As is well known, people at work, students and teachers and individuals at home spend a significant part of both their working day and leisure time using a PC.

As an information machine, personal computers generally enable users to access information from a wide array of sources including software resident on the PC and from sources distant to the PC such as over the internet. As a result of the accessibility of this wide array of information there is a significant potential for a user to misuse the PC by accessing improper information including spending time running inappropriate software or obtaining inappropriate information from other computers.

As a result of the large amount of time spent using PCs and the ability to misuse the computer, there is a need for persons in supervisory positions to monitor PC use to ensure that resources under their supervision are properly utilized and that the degree of misuse is minimized or eliminated. For example, employers may wish to routinely check on the activities of their employees in the work place and teachers and parents may wish to watch the progress and activities of their students and children in a learning environment or otherwise monitor the use of the computer.

Personal surveillance is not always possible or desirable as it requires a supervisor's physical presence in what may often be a private or semi-private location. A physical presence is intrusive, warns the user about being monitored and is expensive to perform, particularly over a wide area.

Video surveillance is another form of surveillance in which one or more video cameras are connected to TV monitors to obtain video images of a particular location or locations. Supervisors can monitor multiple locations and subjects and images can be permanently recorded for later review. While video cameras provide numerous advantages over personal surveillance and are particularly suited for detecting the presence of individuals and physical activities of individuals within the camera's field off view, video cameras are not suited for monitoring the specific activities of a user on a computer.

Accordingly, there has been a need for a system in which specific data relating to a user's activities is obtained from a computer and reported to a central location over a network wherein the data can be reviewed in either real-time or at a later time.

### SUMMARY OF THE INVENTION

In accordance with the invention, there is provided an information gathering system for gathering information over a network comprising:

at least one subject computer having subject computer software for creating at lease one time/data file relating to current subject computer conditions:

a database operatively connected to the subject computer for receiving and storing a plurality of time/data files and for sending at least one time data file to at least one control computer in operative communication with the database.

In further embodiments of the system, various combinations of the following structure and functionality may be included wherein:

a) the at least one control computer includes control software for receiving and displaying at least one time/data file from the database

b) the control software enables a supervisor to request specific time/data files from the database;

c) the control software enables a supervisor to set subject computer software parameters for creating specific time/data files from the subject computer;

d) the database is on an internet web server and the at least one subject computer and the at least one control computer are in operative communication with the database over the internet;

e) the time/data file includes time-specific screen information from a subject computer;

f) The subject computer software obtains subject computer data in accordance with pre-set collection parameters;

g) a plurality of subject computers and a least one controller computer are interconnected over a local area network and wherein the database is located on a network server;

h) a plurality of subject computers and a least one controller computer are interconnected over a wide area network (WAN) and wherein the database is located on a network server,

i) the WAN is the internet;

j) the subject computer software compresses the time/data file prior to forwarding the time/data file to the database;

k) the at least one subject computer and at least one control computer includes a plurality of subject computers and a plurality of control computers and the system further comprises superuser software on one control computer for granting access rights to each of the control computers;

l) reporting parameters of the subject computer are set at installation; and,

m) allowing file sharing across the network.

In another embodiment of the invention a method of obtaining information from at least one subject computer is provided comprising the steps of:

a) creating at least one time/data file relating to current subject computer conditions;

b) forwarding the at least one time/data file to a database operatively connected to the subject computer, the database, for receiving and storing a plurality of time/data files; and

c) sending at least one time/data file to at least one control computer in operative communication with the database.

In a farther embodiment, step c) is imitated from a command signal sent from the least one control computer to the database.

### BRIEF DESCRIPTION OF THE DRAWINGS

The invention will now be described by the following description and drawings wherein:

FIG. 1 is a schematic overview of the deployment of the system in accordance with one embodiment of the invention; and,

FIG. 2 is a schematic diagram of the deployment of the system in accordance with a further embodiment of the invention.

### DESCRIPTION OF THE INVENTION

With reference to the Figures, a system 10 for capturing and delivering data files from at least one computer to another computer is described.

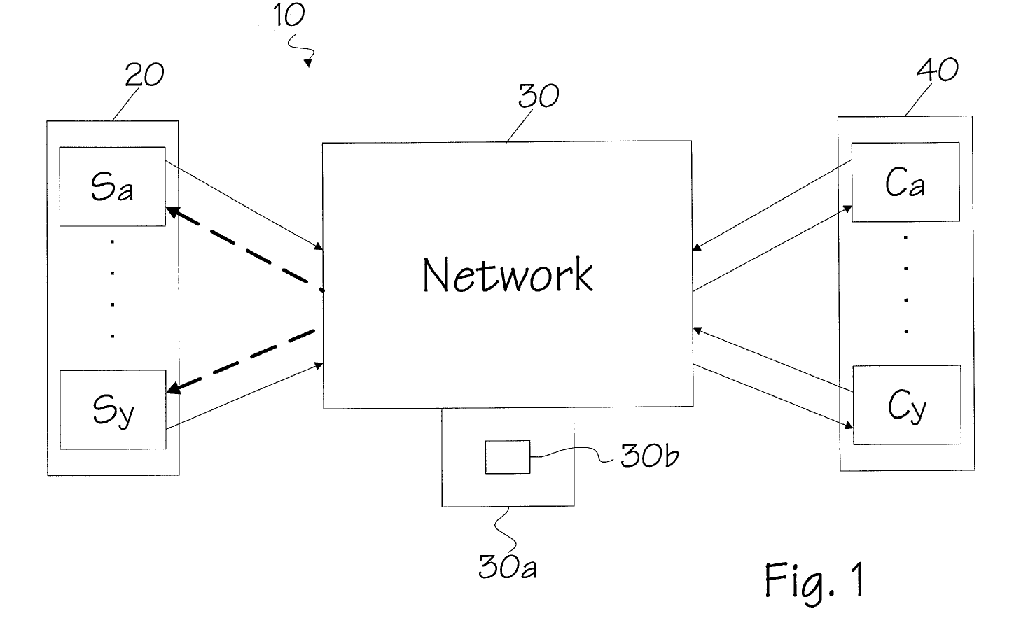

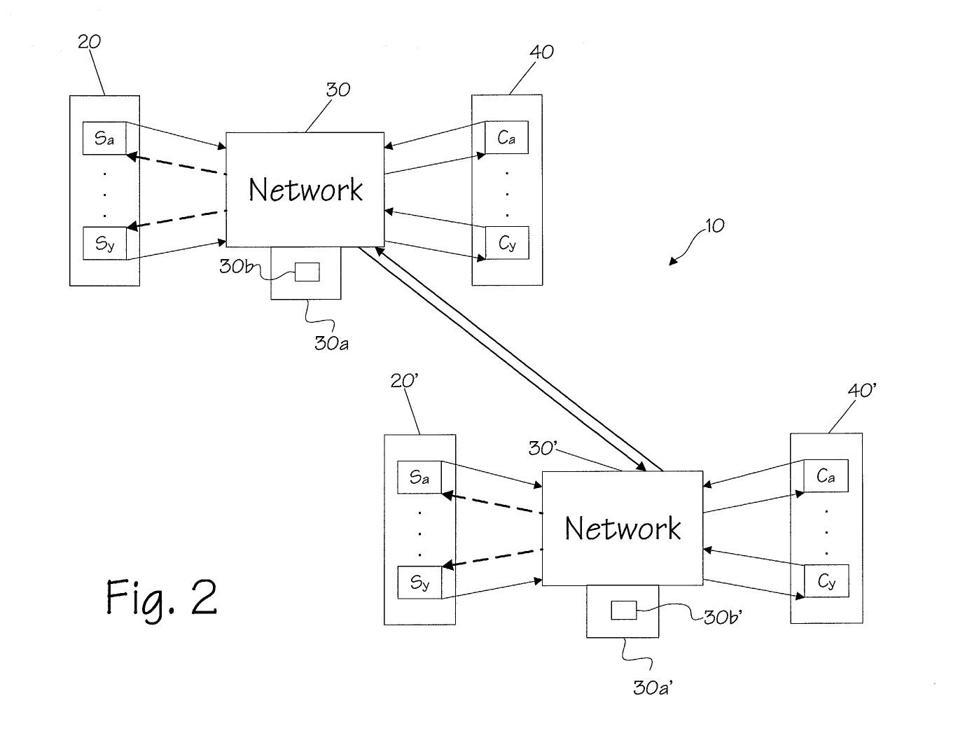

As shown in FIGS. 1 and 2, at least one subject computer 20 (individual computers designated Sa . . . Sy) is operatively connected to a network 30 which is operatively connected to at least one controller computer 40 (individual computers designated Ca . . . Cy). The network 30 may be a local area network or a wide area network or a combination of a local area network and a wide area network (including the internet). At least one network includes a server 30a for storing data fees in a database 30b from each subject computer. Generally, on both the subject and controller computers, surveillance software is either locally installed or installed through the network. The subject computer software posts data to the database 30b according to particular software settings wherein the controller computer software allows access to the database 30b and the display of particular data from the database 30b. The server 30a will also have software for receiving and reporting data to and from the database 30b.

Further embodiments of the deployment of the system and the functionality of the software are described with reference to the Figures.

### Surveillance Software

The functionality of the subject computer software generally enables time specific data from a computer to be captured and reported to the database. At a first level, the subject computer software pushes specific data to the database 30a at pre-determined time intervals based on settings within the subject computer software and the controller computer software receives data from the database. At a second level, the settings for the data capture frequency may be set by the controller computer 40 or by a superuser controlling or providing access rights to different superusers. In this embodiment, command data may be sent to individual subject computers as shown schematically by the dotted lines in FIGS. 1 and 2.

More specifically, at the first level, each subject computer posts data to the database based on a programmed schedule. In this embodiment, the surveillance software is installed on the subject computer and specific reporting parameters provided during installation by the installer. Any subsequent adjustment or changes to the software settings are made by an individual (such as a supervisor or installer) at the subject computer. Accordingly, in his embodiment, surveillance data is only reported to the database and the subject computer does not receive any commands from the control computer(s). The control computers may communicate with the database bi-directionally by requesting information or data from the database and receiving that data from the database or data may be received automatically by the controller computers based on a programmed schedule set by database control software within the server 30a.

At the second level, a supervisor can locally set the frequency with which data is posted to the database from the subject computer by either locally configuring the remote subject computer software to increase or decrease the data collection frequency or by locally configuring the control software for sending data collection commands to the subject computer. A supervisor can similarly modify settings which determine the type of data being written to the database, specify the address of the database or alter other parameters relating to the communication of data.

At the second level, a supervisor can also directly control the subject computer from the control computer. This provides the supervisor with several capabilities including updating the surveillance software by issuing a command from the control computer, executing programs and software resident on the subject computer and operating the subject computer's hardware.

### Wide Area and Local Area Network Deployment

As shown in FIG. 2, the system may also be deployed rising a combination of wide area and local area networks wherein subject and control computers may be interconnected by at least one local area and at least one wide area network. Each network may include separate databases 30a and 30a′ or a single database for tie entire system. With reference to FIG. 2, subject computers 20 may be connected to a local area network 30 whereas subject computers 20′ are connected only to a wide area network 30′ . As shown, the system may include control computers 40 and/or 40′ . As such, control monitoring may be conducted from a control computer 40 of subject computers 20 and/or subject computers 20′ over both the local area or wide area networks. Alternatively, local area network 30 may not include control computer 40 wherein monitoring of subject computers 20 is conducted from control computer 40′ over wide area network 30′ and local area network 30.

In a further embodiment, each network 30, 30′ may be provided with individual databases 30b, 30b′ depending upon the specific deployment objective. However, it is envisaged that for most deployments, a single database is provided.

In a preferred embodiment, the system is deployed across the internet thereby permitting a wide area deployment, wherein the database is located on a web server (eg 30a′ ) having an IP address.

In an internet deployment, a subject computer maintains a connection to the web server prior to posting the data. In a preferred embodiment, the subject computer maintains a secure connection to the web server to ensure that any confidential information contained in the data cannot be viewed or intercepted by anyone other than a controller computer operator with the rights to access the web server.

### Supervisor Access Rights

Once the data is written to the database, the data can be accessed at any time by a supervisor at a control computer who has access rights to the database. As indicated above, at least two levels of access rights are preferably available for supervisors: a superuser level and a monitor level. At the superuser level, a supervisor can access the database and change settings which determine which subject computers each supervisor can monitor. At the monitor level, a supervisor can access the database but is only entitled to monitor subject computers which they have been given authority to view by a superuser and superuser software installed on one control computer.

The supervisor can preferably configure the controller software to update the display of each monitored subject computer based on each subject computer's posting schedule or at another pre-determined interval. This allows the controller computer operator to view data intermediately after it is posted by the subject computer or at a specifically determined time.

In a further embodiment, a supervisor may issue commands through a customized template in the controller software to provide commands to subject computers to post data to the database.

### Simultaneous File Sharing

In another embodiment, the subject computer and control computer software allows simultaneous file sharing across the network, wherein specific files can be sent directly between different computers on the network in real-time.

### Data Types

The data captured from a subject computer may be any data type reflecting any aspect of user activity on the subject computer. By way of example, in one embodiment, the surveillance software may capture the data of a specific screen image in device independent bitmap format. In other embodiments, application specific data files may be captured.

In the example of screen image data, the surveillance software will preferably compress the image data before posting the image to the database to conserve bandwidth; the compression algorithm may be any algorithm known to persons skilled in the art including compression to the “jpeg” and “gif” formats. In another embodiment, the surveillance system may be configured to post ascii text which describes the subject computer's operating parameters to the database.

In another embodiment, the surveillance software may interpret, evaluate or compile data on the subject computer and then render a representation of the data in graphical or text form which is then posted to the database. The data may be interpreted, evaluated or compiled using software other than the surveillance software and which may be posted in any data type to the database and may include sensitive or confidential data.

Once the data is posted to the database, the database can be manipulated to summarize and interpret the information in various ways that are well known to persons skilled in the art. In one embodiment, the data can be synchronized by its time stamp to create a video of captured data. The video can then be manipulated in various ways that are well known to persons skilled in the art, including adding audio and streaming the video.

We claim:

1. An information gathering system for gathering information over a network comprising:
at least one subject computer having subject computer software for creating at least one time/data file relating to current subject computer conditions.
a database operatively connected to the subject computer for receiving and storing a plurality of time/data files and for sending at least one time/data file to at least one control computer in operative communication with the database.

2. An information gathering system as in claim 1 wherein the at least one control computer includes control software for receiving and displaying at least one time/data file from the database.

3. An information gathering system as in claim 1 wherein the control software enables a supervisor to request specific time/data files from the database.

4. An information gathering system as in claim 1 wherein the control software enables a supervisor to set subject computer software parameters for creating specific time/data files from the subject computer.

5. An information gathering system as in claim 1 wherein the database is on an internet web server and the at least one subject computer and the at least one control computer are in operative communication with the database over the internet.

6. An information gathering system as in claim 1 wherein the time/data file includes timespecific screen information from a subject computer.

7. An information gathering system as in claim 1 wherein the subject computer software obtains subject computer data in accordance with pre-set collection parameters

8. An information gathering system as in claim 1 wherein a plurality of subject computers and a least one controller computer are interconnected over a local area network and wherein the database is located on a network server.

9. An information gathering system as in claim 1 wherein a plurality of subject computers and a least one controller computer are interconnected over a wide area network (WAN) and wherein the database is located on a network server.

10. An information gathering system as in claim 9 wherein the WAN is the internet.

11. An information gathering system as in claim 1 wherein the subject computer software compresses the time/data file prior to forwarding the time/data file to the database.

12. An information gathering system as in claim 1 wherein the at least one subject computer and at least one control computer includes a plurality of subject computers and a plurality of control computers and the system further comprises superuser software on one control computer for granting access rights to each of the control computers.

13. An information gathering system as in claim 1 wherein reporting parameters of the subject computer are set at installation,

14. An information gathering system as in claim 2 wherein the control software enables a supervisor to request specific time/data files from the database.

15. An information gathering system as in claim 14 wherein the control software enables a supervisor to set subject computer software parameters for creating specific time/data files from the subject computer.

16. An information gathering system as in claim 15 wherein the database is on an internet web server and the at least one subject computer and the at least one control computer are in operative communication with the database over the internet.

17. An information gathering system as in claim 16 wherein the time/data file includes time-specific screen information from a subject computer.

18. As information gathering system as in claim 17 wherein a plurality of subject computers and a least one controller computer are interconnected over a wide area network (WAN) and wherein the database is located on a network server.

19. An information gathering system as in claim 18 wherein the WAN is the internet.

20. An information gathering system as in claim 19 wherein the subject computer software compresses the time/data file prior to forwarding the time/data file to the database.

21. An information gathering system as in claim 20 wherein the at least one subject computer and at least one control computer includes a plurality of subject computers and a plurality of control computers and the system further comprises superuser software on one control computer for granting access rights to each of the control computers.

22. An information gathering system as in claim 1 wherein the subject computer software and control computer software permits bidirectional file sharing between the computers.

23. A method of obtaining information from at least one subject computer comprising the steps of:
a) creating at least one time/data file relating to current subject computer conditions;
b) forwarding the at least one time/data file to a database operatively connected to the subject computer, the database for receiving and storing a plurality of time/data files; and
c) sending at least one time/data file to at least one control computer in operative communication with the database.

24. A method as in claim 22 wherein step c) is initiated from a command signal sent from the at least one control computer to the database.
